(19) United States
(12) Patent Application Publication
(10) Pub. No.: US 2011/0037670 A1
(43) Pub. Date: Feb. 17, 2011

(54) RADIO COMMUNICATION SYSTEM AND METHOD OF SETTING THE SAME

(75) Inventor: Koji Terahara, Shizuoka-ken (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/854,251

(22) Filed: Aug. 11, 2010

(30) Foreign Application Priority Data
Aug. 13, 2009 (JP) 2009-187815

(51) Int. Cl. H01Q 11/02

(52) U.S. Cl. 343/737

(57) ABSTRACT

According to one embodiment, a radio communication system includes at least two leaky transmission lines provided in parallel to each other and configured to radiate a part of electric signal energy to a space as radio waves and receive incidence of radio waves from the outside. At least two antenna elements have directivity in the radiation and the incidence of the radio waves, respectively perform the radiation and the incidence of the radio waves to and from the leaky transmission lines corresponding thereto among the leaky transmission lines, and is set in directions in which the radio waves radiated and made incident to and from the leaky transmission lines do not cross each other.

### CROSS-REFERENCE TO RELATED APPLICATIONS

This application is based upon and claims the benefit of priority from the prior Japanese Patent Application No. 2009-187815, filed on Aug. 13, 2009, the entire contents of which are incorporated herein by reference.

### FIELD

Embodiments described herein relate generally to a radio communication system employing a leaky transmission line such as a leaky coaxial cable (hereinafter referred to as LCX cable) and a method of setting the same.

### BACKGROUND

An LCX cable radiates a part of electric signal energy to a space along the cable as a radio wave. The radiation of the radio wave is also referred to as “the radio wave leaks”. The LCX cable is configured by mainly providing an internal conductor and an external conductor coaxially. In the external conductor, plural slots are provided in a length direction at every fixed interval. The LCX cable radiates a part of electric signal energy, which is transmitted from the slots to the internal conductor, to the outside as a radio wave and receives a radio wave on the outside through the slots. If an antenna is set in an area covered by the radio wave radiated from the LCX cable, it is possible to transmit and receive the radio wave between the LCX cable and the antenna.

### BRIEF DESCRIPTION OF THE DRAWINGS

FIG. 1 is a diagram of the configuration of an LCX radio LAN system of a first embodiment;

FIG. 2 is a diagram of the configuration of LCX cables in the system;

FIG. 3 is a diagram of the configuration of antennas in the system;

FIG. 4 is a diagram of setting of the antennas in the system;

FIG. 5 is a diagram of an example in which the system is applied to a building;

FIG. 6 is a diagram of an example in which the antennas are movable in the system;

FIG. 7 is a diagram of a state in which the antennas can be set in the system;

FIG. 8 is a diagram of another state in which the antennas can be set in the system;

FIG. 9 is a diagram of a modification of a method of setting the antennas in the system; and

FIG. 10 is a diagram of still another state in which the antennas can be set in the system.

### DETAILED DESCRIPTION

In general, according to one embodiment, a radio communication system includes: at least two leaky transmission lines provided in parallel to each other and configured to radiate a part of electric signal energy to a space as radio waves and receive incidence of radio waves from the outside; and at least two antenna elements having directivity in the radiation and the incidence of the radio waves, configured to respectively perform the radiation and the incidence of the radio waves to and from the leaky transmission lines corresponding thereto among the leaky transmission lines, and set in directions in which the radio waves radiated and made incident to and from the leaky transmission lines do not cross each other.

An embodiment of the present invention is explained below with reference to the accompanying drawings.

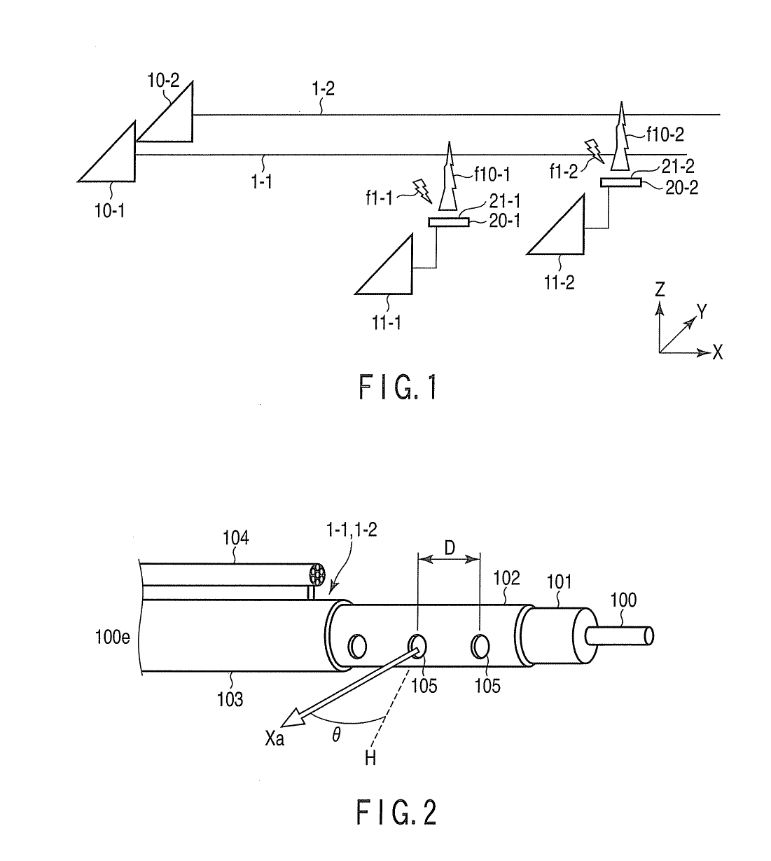

FIG. 1 is a diagram of a configuration of an LCX radio LAN system as a radio communication system. The system is laid in a facility such as a warehouse, a store, a road, or a tunnel. In the system, for example, two LCX cables 1-1 and 1-2 are laid to expand an area covered by radio waves.

In the system, for example, two access points 10-1 and 10-2 are provided. The access points 10-1 and 10-2 respectively include radio communication apparatuses. The LCX cables 1-1 and 1-2 are respectively connected to the radio communication apparatuses of the access points 10-1 and 10-2. The access point 10-1 transmits an electric signal to the LCX cable 1-1 and receives an electric signal from the LCX cable 1-1 with the radio communication apparatus. The access point 10-2 transmits an electric signal to the LCX cable 1-2 and receives an electric signal from the LCX cable 1-2 with the radio communication apparatus.

Electric signals in different channels for the respective access points 10-1 and 10-2, i.e., electric signals having different frequencies are respectively transmitted to the LCX cables 1-1 and 1-2. In the LCX cables 1-1 and 1-2, sides to which the access points 10-1 and 10-2 are connected are base ends and the opposite sides are terminal ends.

FIG. 2 is a diagram of the configuration of each of the LCX cables 1-1 and 1-2 of a coaxial type. Each of the LCX cables 1-1 and 1-2 is formed by an internal conductor 100, an insulator 101, an external conductor 102, a sheath 103, and a supporting member 104. The internal conductor 100 is formed in a linear shape (a wire shape). The internal conductor 100 transmits an electric signal transmitted from, for example, each of the access points 10-1 and 10-2. The insulator 101 is provided to surround the outer circumference of the internal conductor 100. The external conductor 102 is formed in a cylindrical shape and provided on the outer circumference of the insulator 101. The internal conductor 100 and the external conductor 102 are coaxially provided. The sheath 103 is provided to cover the outer circumference of the external conductor 102. The supporting member 104 is formed in a cable shape and provided on the outer circumferential surface of the sheath 103 along the axis direction of the cables 1-1 and 1-2. In the external conductor 102, plural slots 105 are provided in the axis direction at every fixed interval D.

Each of the LCX cables 1-1 and 1-2 radiates a part of electric signal energy, which is transmitted to the internal conductors 100, to the outside from the slots 105 as electric waves and receives radio waves on the outside through the slots 105. A direction Xa of the radiation and incidence of the radio waves in the slots 105 tilts to a terminal end 100e side by an angle θ with respect to a direction H orthogonal to the axis direction. The angle θ is determined according to the fixed interval D of the slots 105 and a frequency of an electric signal transmitted to the internal conductor 100. The LCX cable 1-1 radiates a radio wave f1-1. The LCX cable 1-2 radiates a radio wave f1-2.

The LCX cables 1-1 and 1-2 are provided in parallel to each other. The LCX cables 1-1 and 1-2 are laid on paths including one or both of linear and bent paths in a facility such as a warehouse, a store, a road, or a tunnel.

An antenna (an antenna element) 20-1 is provided to be opposed to the LCX cable 1-1. The antenna 20-1 corresponds to a client 11-1 and performs transmission and reception of radio waves to and from the LCX cable 1-1.

An antenna (an antenna element) 20-2 is provided to be opposed to the LCX cable 1-2. The antenna 20-2 corresponds to a client 11-2 and performs transmission and reception of radio waves to and from the LCX cable 1-2.

The antennas 20-1 and 20-2 are fixedly set. The antennas 20-1 and 20-2 may be placed on a truck, a cart, a forklift, or an automobile and respectively provided to be movable along the LCX cables 1-1 and 1-2.

The client 11-1 includes a radio communication apparatus. The antenna 20-1 is connected to the client 11-1. The client 11-1 transmits an electric signal to the LCX cable 1-1 through the antenna 20-1 and receives an electric signal from the LCX cable 1-1 through the antenna 20-1 with the radio communication apparatus.

The client 11-2 includes a radio communication apparatus. The antenna 20-2 is connected to the client 11-2. The client 11-2 transmits an electric signal to the LCX cable 1-2 through the antenna 20-2 and receives an electric signal from the LCX cable 1-2 through the antenna 20-2 with the radio communication apparatus.

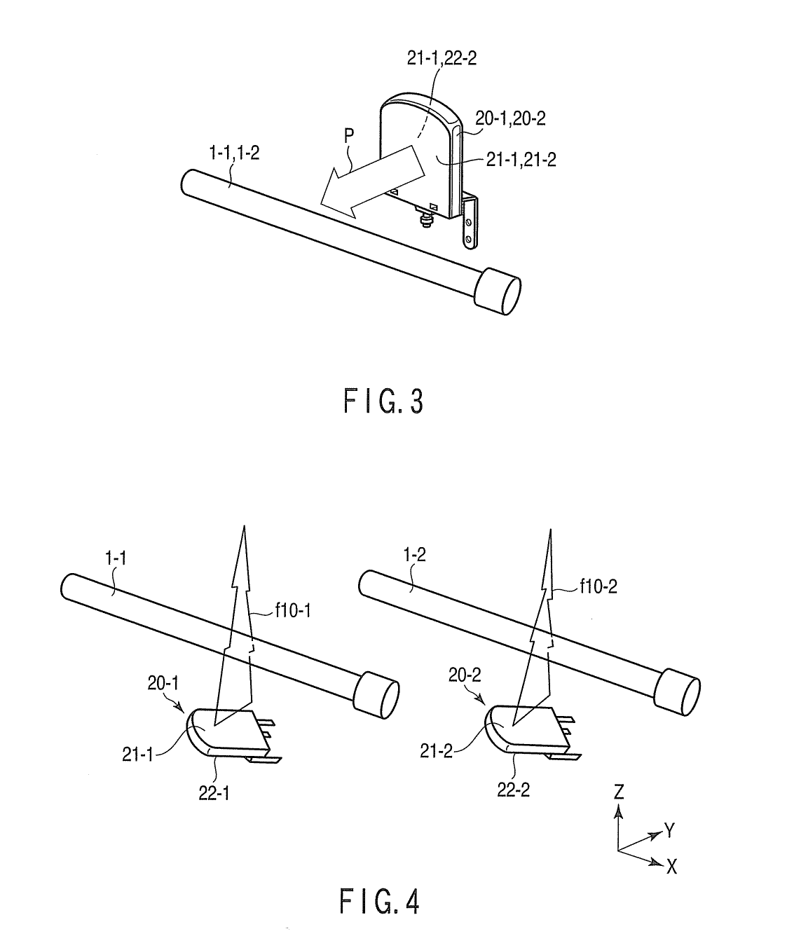

FIG. 3 is an external diagram of the antennas 20-1 and 20-2. In the antennas 20-1 and 20-2, flat surfaces (hereinafter referred to as transmission and reception surfaces) 21-1 and 21-2 formed in a flat shape and functioning as transmission and reception surfaces for radio waves and rear surfaces 22-1 and 22-2 of the transmission and reception surfaces 21-1 and 21-2 are respectively formed. The antennas 20-1 and 20-2 have directivity P in radio waves f10-1 and f10-2 respectively transmitted from the transmission and reception surfaces 21-1 and 21-2. The antennas 20-1 and 20-2 have the directivity P for transmitting radio waves in a vertical direction of the transmission and reception surfaces 21-1 and 21-2, i.e., toward a space area in the front of the transmission and reception surfaces 21-1 and 21-2.

The antennas 20-1 and 20-2 are respectively set in directions in which the radio waves f10-1 and f10-2 radiated to and from the LCX cables 1-2 and 1-1 do not cross each other.

Specifically, the antennas 20-1 and 20-2 are set to have the directivity P in a direction along a vertical direction (a z direction) with respect to a horizontal plane (an xy plane), for example, a direction toward a positive side in the z direction (a direction from down to up) as shown in FIG. 4. The antennas 20-1 and 20-2 are respectively set with the transmission and reception surfaces 21-1 and 21-2 set in parallel to the horizontal plane (the xy plane), the transmission and reception surfaces 21-1 and 21-2 directed to the positive side of the vertical direction (z direction), and the rear surfaces 22-1 and 22-2 directed to a negative side of the vertical direction (the z direction).

The directions of the directivity P of the antennas 20-1 and 20-2 are parallel to each other. In other words, radiation direction of the radio waves f10-1 and f10-2 radiated from the antennas 20-1 and 20-2 are parallel to each other.

The antennas 20-1 and 20-2 are arranged to have the directivity P in the direction toward the positive side in the z direction as shown in FIG. 4. However, the antennas 20-1 and 20-2 may be set to have the directivity P in a direction toward the negative side of the z direction. One of the antennas 20-1 and 20-2 may be set to have the directivity P in the direction toward the positive side of the z direction and the other may be set to have the directivity P in the direction toward the negative side of the z direction.

In this way, according to the embodiment, the directivity P is given to the antennas 20-1 and 20-2 and the antennas 20-1 and 20-2 are set in the directions in which the radio waves f10-1 and f10-2 transmitted to the LCX cables 1-1 and 1-2 respectively corresponding to the antennas 20-1 and 20-2 do not cross each other. Consequently, the radio wave f10-1 transmitted from the antenna 20-1 on the client 11-1 side is received by the LCX cable 1-1 and does not reach the LCX cable 1-2 in another channel. Similarly, the radio wave f10-2 transmitted from the antenna 20-2 on the client 11-2 side is received by the LCX cable 1-2 and does not reach the LCX cable 1-1 in another channel adjacent to the LCX cable 1-2.

Therefore, the radio waves f10-1 and f10-2 transmitted from the antennas 20-1 and 20-2 of the clients 11-1 and 11-2 do not cross each other irrespectively of the intensities of the radio waves f10-1 and f10-2. As a result, radio wave interference between the LCX cables 1-1 and 1-2 in different channels set adjacent to and in parallel to each other can be prevented. Even when two LCX radio LAN systems are provided, a stable radio environment (communication) can be obtained.

The LCX cables 1-1 and 1-2 in the channels different from each other have overlap in frequencies of transmitted and received radio waves. In some case, the LCX cables 1-1 and 1-2 are affected by near channels. Therefore, it is recommended to space apart the LCX cables 1-1 and 1-2 in order to prevent the influence of the overlap. In some case, it is difficult to space apart the LCX cables 1-1 and 1-2 depending on states such as the number of LCX radio LAN systems to be set, the configuration of the LCX radio LAN systems, and a building in which the LCX radio LAN systems are arranged. Even in such a case, if the directivity P is given to the antennas 20-1 and 20-2 and the antennas 20-1 and 20-2 are arranged in the directions in which the radio waves f10-1 and f10-2 transmitted from the antennas 20-1 and 20-2 do not cross each other, radio wave interference between the LCX cables 1-1 and 1-2 can be prevented.

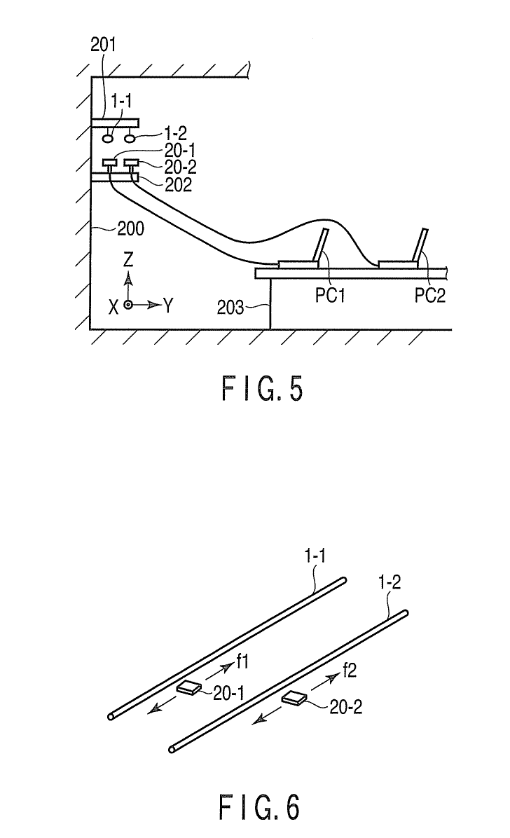

The LCX radio LAN system provided in a building such as a factory is explained with reference to FIG. 5.

In the building such as a factory, there is no space for laying the LCX cables 1-1 and 1-2 space apart from each other. In such a building, the LCX cables 1-1 and 1-2 are provided in parallel to each other in, for example, an upper part of a wall 200 in a room. A supporting member 201 is provided on the wall 200. The LCX cables 1-1 and 1-2 are supported by the supporting member 201. The LCX cables 1-1 and 1-2 are provided in parallel to each other on paths including one or both of linear and bent paths in the building.

The antennas 20-1 and 20-2 are arranged on the wall 200 in the room below the LCX cables 1-1 and 1-2. A supporting member 202 is provided on the wall 200. The antennas 20-1 and 20-2 are set on the supporting member 202.

In the same manner as shown in FIG. 4, the antennas 20-1 and 20-2 are arranged in the directions in which the radio waves f10-1 and f10-2 radiated to and from the LCX cables 1-1 and 1-2 do not cross each other. Specifically, the antennas 20-1 and 20-2 are arranged with the transmission and reception surfaces 21-1 and 21-2 directed in the vertical direction (the z direction) with respect to the horizontal plane (the xy plane). The antennas 20-1 and 20-2 are respectively connected to, for example, personal computers PC1 and PC2 set on a desk 203.

In this way, even when it is difficult to space apart the LCX cables 1-1 and 1-2 as in the building such as a factory, radio wave interference between the LCX cables 1-1 and 1-2 can be prevented.

In the building, the antennas 20-1 and 20-2 may be provided to be respectively movable in moving directions f1 and f2 as shown in FIG. 6. For example, an antenna moving mechanism is provided on the supporting member 202 shown in FIG. 5 and the antennas 20-1 and 20-2 can be respectively moved in the moving directions f1 and f2 by the antenna moving mechanism. The antenna moving mechanism includes, for example, an endless belt, plural rollers configured to drive the belt, and a motor configured to rotate the rollers.

The antennas 20-1 and 20-2 may be respectively mounted on work robots and configured to be movable in the moving directions f1 and f2 together with the work robots. The work robots perform, for example, various kinds of work. The work robots receive an instruction for work via, for example, the antenna 20-1 and perform the various kinds of work. The work robots can perform the various kinds of work in positions to which the work robots move.

The embodiment may be modified as explained below.

Two or more LCX cables may be disposed. When the plural LCX cables are disposed, plural antennas are disposed to correspond to the plural LCX cables. The plural antennas are set in directions in which radio waves respectively radiated by the antennas do not cross one another.

Another method of setting the antennas 20-1 and 20-2 is explained.

The antennas 20-1 and 20-2 are set in directions in which directions of radiation and incidence of radio waves to and from the LCX cables 1-1 and 1-2 are opposed to each other.

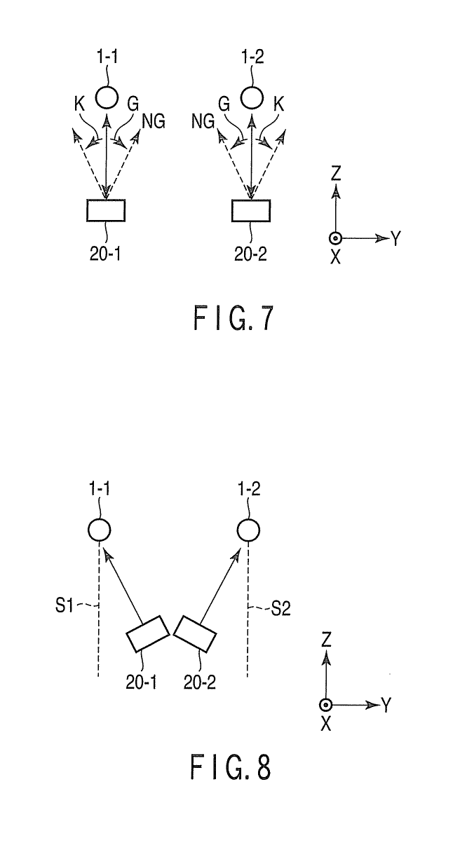

FIG. 7 is a diagram of a setting example of, for example, the two LCX cables 1-1 and 1-2 and the two antennas 20-1 and 20-2. The antennas 20-1 and 20-2 are respectively provided to be opposed to the LCX cables 1-1 and 1-2. Radio waves transmitted from the antennas 20-1 and 20-2 are parallel to each other.

When the antennas 20-1 and 20-2 are set in directions G in which the transmission and reception surfaces 21-1 and 21-2 face each other, radio waves transmitted from the antennas 20-1 and 20-2 cross each other. On the other hand, when the antennas 20-1 and 20-2 are set in directions K in which the rear surfaces 22-1 and 22-2 face each other, the radio waves transmitted from the antennas 20-1 and 20-2 do not cross each other.

Therefore, as shown in FIG. 8, the antennas 20-1 and 20-2 are set between planes S1 and S2 parallel to each other respectively passing through the LCX cables 1-1 and 1-2 and with the rear surfaces 22-1 and 22-2 facing each other. In other words, the antennas 20-1 and 20-2 are provided with the transmission and reception surfaces 21-1 and 21-2 directed away from each other outward.

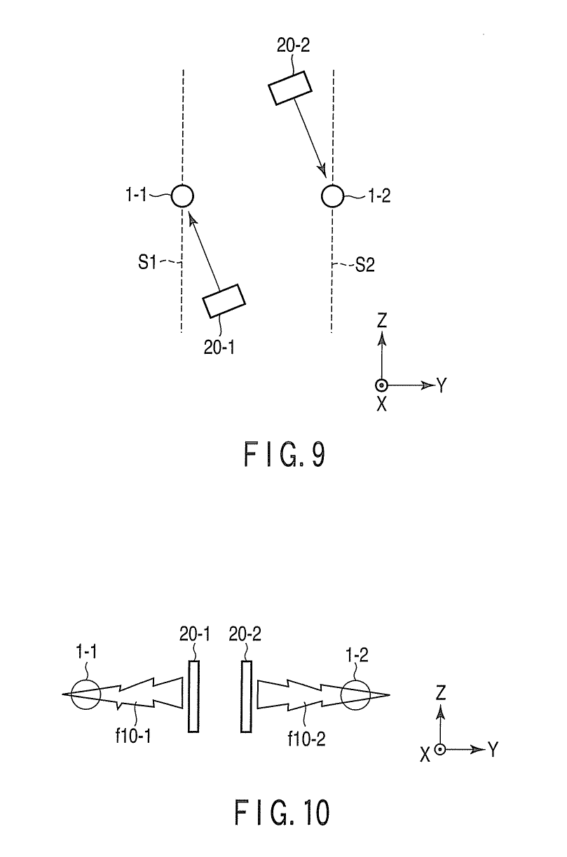

FIG. 9 is a diagram of a modification of the method of setting the antennas 20-1 and 20-2. For example, the antenna 20-2 is set on the opposite side of the antenna 20-1 via the LCX cables 1-1 and 1-2 between the planes S1 and S2 parallel to each other respectively passing through the LCX cables 1-1 and 1-2. Radio waves transmitted from the antennas 20-1 and 20-2 are parallel to each other. The radio waves transmitted from the antennas 20-1 and 20-2 do not cross each other.

FIG. 10 is a diagram of a plain example in which the transmission and reception surfaces 21-1 and 21-2 of the antennas 20-1 and 20-2 are provided away from each other outward. The antennas 20-1 and 20-2 are arranged between the LCX cables 1-1 and 1-2 with the rear surfaces 22-1 and 22-2 opposed to each other. The antennas 20-1 and 20-2 are set on planes respectively passing through the LCX cables 1-1 and 1-2. Transmission directions of the radio waves f10-1 and f10-2 radiated from the antennas 20-1 and 20-2 are opposite to each other. The radio waves transmitted from the antennas 20-1 and 20-2 do not cross each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A radio communication system comprising:
at least two leaky transmission lines provided in parallel to each other and configured to radiate a part of electric signal energy to a space as radio waves and receive incidence of radio waves from an outside; and
at least two antenna elements having directivity in the radiation and the incidence of the radio waves, configured to respectively perform the radiation and the incidence of the radio waves to and from the leaky transmission lines corresponding thereto among the leaky transmission lines, and set in directions in which the radio waves radiated and made incident to and from the leaky transmission lines do not cross each other.

2. The system according to claim 1, wherein the antenna elements are set such that the radio waves radiated and made incident to and from the leaky transmission lines are parallel to each other.

3. The system according to claim 1, wherein the antenna elements are set such that directions in which the radio waves are radiated and made incident to and from the leaky transmission lines are directions opposite to each other.

4. The system according to claim 1, wherein
in the antenna elements, transmission and reception surfaces from which the radio waves are radiated and on which the radio waves are made incident and rear surfaces of the transmission and reception surfaces are respectively formed, and
the transmission and reception surfaces are set away from each other outward.

5. The system according to claim 4, wherein the transmission and reception surfaces are formed in a plane shape and the antenna elements have the directivity of the radio waves in a direction perpendicular to the transmission and reception surfaces.

6. The system according to claim 4, wherein the antenna elements are set between the leaky transmission lines with the transmission and reception surfaces opposed to the leaky transmission lines respectively corresponding thereto.

7. The system according to claim 6, wherein the antenna elements are set on planes respectively passing through the leaky transmission lines.

8. The system according to claim 1, wherein the antenna elements are set in areas in which the radio waves can be radiated and made incident to and from the leaky transmission lines.

9. The system according to claim 1, wherein the leaky transmission lines respectively transmit electric signals in different channels.

10. A method of setting a radio communication system comprising:
disposing at least two leaky transmission lines provided in parallel to each other and configured to radiate a part of electric signal energy to a space as radio waves and receive incidence of radio waves from an outside; and
disposing at least two antenna elements configured to respectively perform the radiation and the incidence of the radio waves to and from the leaky transmission lines corresponding thereto among the leaky transmission lines, wherein
the antenna elements have directivity in the radiation and the incidence of the radio waves and are set in directions in which the radio waves radiated and made incident to and from the leaky transmission lines do not cross each other.

11. The method according to claim 10, wherein the antenna elements are set such that the radio waves radiated and made incident to and from the leaky transmission lines are parallel to each other.

12. The method according to claim 10, wherein the antenna elements are set such that directions in which the radio waves are radiated and made incident to and from the leaky transmission lines are directions opposite to each other.

13. The method according to claim 10, wherein
in the antenna elements, transmission and reception surfaces from which the radio waves are radiated and on which the radio waves are made incident and rear surfaces of the transmission and reception surfaces are respectively formed, and
the transmission and reception surfaces are set away from each other outward.

14. The method according to claim 13, wherein the transmission and reception surfaces are formed in a plane shape and the antenna elements have the directivity of the radio waves in a direction perpendicular to the transmission and reception surfaces.

15. The method according to claim 13, wherein the antenna elements are set between the leaky transmission lines with the transmission and reception surfaces opposed to the leaky transmission lines respectively corresponding thereto.

16. The method according to claim 15, wherein the antenna elements are set on planes respectively passing through the leaky transmission lines.

17. The method according to claim 10, wherein the antenna elements are set in areas in which the radio waves can be radiated and made incident to and from the leaky transmission lines.
